(19) United States
(12) Patent Application Publication
(10) Pub. No.: US 2007/0250689 A1
(43) Pub. Date: Oct. 25, 2007

(54) Method and apparatus for improving data and computational throughput of a configurable processor extension

(76) Inventors: Aris Aristodemou, London (GB); Amnon Baron Cohen, London (GB); Kar-Lik Wong, Wokingham (GB); Ryan S.C. Lim, Thatcham (GB); Simon Jones, London (GB)

Correspondence Address: GAZDZINSKI & ASSOCIATES, Suite 375, 11440 West Bernardo Court, San Diego, CA, 92127, US

(21) Appl. No.: 11/728,061

(22) Filed: Mar. 22, 2007

Related U.S. Application Data
(60) Provisional application No. 60/785,276, filed on Mar. 24, 2006.

(51) Int. Cl. G06F 15/00

(52) U.S. Cl. 712/221; 712/34

(57) ABSTRACT

Methods and apparatus adapted for enhancing the throughput of a digital processor (e.g., microprocessor, CISC device, or RISC device) through use of a direct memory access (DMA) mechanism. In one embodiment, the processor comprises a “soft” RISC-based processor core that is both user-extensible and user-configurable. The core comprises a functional process or unit (DMA assist) that is coupled to the processor's extension logic and which facilitates throughput by, among other things, ensuring that the CPU and processor extension logic can operate on data in parallel in an efficient manner. In one variant, a parallel datapath (including a buffer) is used in conjunction with the aforementioned DMA assist so as to permit the processor extension logic to efficiently operate in parallel with the CPU.

### PRIORITY AND RELATED APPLICATIONS

The present application claims priority to U.S. Provisional Application Ser. No. 60/785,276 entitled “METHOD AND APPARATUS OF A DIRECT MEMORY ACCESS (DMA) MECHANISM TO IMPROVE DATA AND COMPUTATIONAL THROUGHPUT OF A CONFIGURABLE PROCESSOR EXTENSION” filed Mar. 24, 2006, and incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Field of the Invention

The invention generally relates to microprocessor architecture, and more specifically in one exemplary aspect to a Direct Memory Access (DMA) mechanism for improving computational and data throughput of a microprocessor employing processor extension logic.

2. Description of the Related Technology

An extendible microprocessor is a processor designed to facilitate the addition of application specific processor extensions—logic, hardware and/or instructions that supplement the main processor pipeline and instruction set. Application specific processor extensions accelerate the execution of specific computations required by a targeted application by offloading particular functions from the primary processor pipeline.

A problem with general-purpose (GP) microprocessors is that they are often highly inefficient in performing tasks involving low-level bit manipulation of large data sets. One reason for this is that GP microprocessors typically process data in fixed length data words. Therefore, because the data being processed is frequently not aligned with respect to the word boundaries of the fixed length data words, inefficiency occurs. For variable length bit-stream data, a fixed length data word containing the bit-stream data may include several encoded symbols, where each end of the data word contains part of a coded symbol instead of a complete symbol.

An example of a data word having variable length bit-stream data unaligned with the word boundaries of the fixed length data word is illustrated in FIG. 1. In this example, the GP microprocessor may process a data word having 32 bits of variable length bit-stream data, where the bit-stream data may comprise a series of symbols of varying bit lengths that are not all aligned with the boundaries of the data word. FIG. 1 depicts a data word 100 having 32-bits, where the data word 100 is one of a sequence of 32-bit data words that may be processed by the GP microprocessor. The data word 100 contains part of Symbol A 102 (bits 0-9), all of a Symbol B 104 (bits 10-14), all of a Symbol C 106 (bits 15-20), and part of a Symbol D 108 (bits 21-31). In this example, the leading part of Symbol A is in the preceding 32-bit data word, while the remaining part of Symbol D is in the following 32-bit data word. Because the beginning of Symbol A does not occur at the beginning of the 32-bit data word, Symbol A is not aligned with respect to the word boundary. Analogously, Symbol D does not end at the end of the 32-bit word and is also not aligned. A symbol also may be unaligned with the data word 100 boundary when the symbol fails to start or end with the data word boundary, as exemplified by symbols B and C of FIG. 1. Therefore, the GP microprocessor is processing symbols A-D not aligned with the word boundary of the 32-bit data word 100. It should be appreciated that the specific type of non-alignment depicted in FIG. 1 is exemplary only.

To extract a non-aligned variable-length symbol from a fixed length data word, the GP microprocessor first has to determine where the symbol is located within the fixed length data word, and then determine the number of bits in the symbol. After this, the GP processor may perform a shift operation to align the symbol with the data word boundary, and then remove the remaining bits from the other symbols in the shifted data word. Removal of the remaining bits can be achieved by first producing a bit mask based on the size of the desired symbol and then performing a bitwise logical ‘OR’ operation using this bit mask and the shifted data word. Since these operations have to be performed for every symbol, the total processing overhead incurred becomes huge.

To overcome the problem of unaligned data words, conventional systems may use an extension datapath. An extension datapath is an alternative datapath that handles particular instructions for the primary datapath. The extension datapath may allow processing of compressed variable length bit-stream data to occur in parallel with the GP microprocessor's processing of other instructions. FIG. 2 illustrates a conventional microprocessor architecture 200 implementing an extension datapath. In the example of FIG. 2, the architecture 200 includes an extension processor 202, a GP microprocessor 204, a memory 206, and an extension logic data input (ELDI) buffer 208. Also depicted in the FIG. 2 are an extension interface 210 that couples the ELDI buffer 208 with the GP microprocessor 204, a GP memory interface 214 that couples the GP microprocessor 204 with the memory 206, and a result datapath 212 that couples the extension processor 202 with the GP microprocessor 204. The extension datapath is the path beginning at the extension interface 210 of the GP microprocessor 204, continuing to the ELDI buffer 208, further continuing to the extension processor 202, and returning to the GP microprocessor 204 through the result datapath 212.

The extension processor 202 may be specifically designed to process encoded bit-stream data, where the bit-stream data includes variable length data symbols. The extension processor 202 may decode the bit-stream data to retrieve symbols, such as symbols A-D of FIG. 1, and forward the symbols to the GP microprocessor 204.

A problem with the conventional architecture 200 of FIG. 2 is that the GP microprocessor 204 incurs significant control overhead by ensuring that data is properly supplied to the extension processor 202. When processing data, the GP microprocessor 204 must dispatch a 32-bit load instruction that fetches a data word from the memory 206. The GP microprocessor 204 must then send the fetched data word to the ELDI buffer 208 for queuing. Once queued, the extension processor 202 may request one or more data words from the ELDI buffer 208 for processing. Once received, the extension processor 202 may decode the fetched data word. After the extension processor 202 decodes a complete symbol, the extension processor 202 forwards the decoded symbol to the GP microprocessor 204 through the result datapath 212.

Next, the GP microprocessor 204 determines whether to fetch another data word from the memory 206 for processing by the extension processor 202. In its fetch determination, the GP microprocessor 204 polls the extension processor 202 each time before fetching another data word from the memory 206. If polling indicates that the extension processor 202 does not need another data word (i.e., the ELDI buffer 208 already contains a sufficient amount of data words for the extension processor 202 to perform a decode operation), the GP microprocessor 204 processes a conditional branch instruction, and skips over an instruction sequence that generates the 32-bit load instruction to load a data word from the memory 206.

A problem occurs when the GP microprocessor 204 skips the 32-bit load instruction and executes a conditional branch that takes several cycles to perform. Since the extension processor 202 is designed to efficiently decode the data words containing the bit-stream data, the extension processor 202 will often decode a symbol (e.g., symbol A, B, C, or D) in a small number of processor clock cycles. As a result, while the GP microprocessor 204 executes the instructions in the conditional branch, the ELDI buffer 208 may run out of data words and cause the processor extension logic 102 to become idle.

Typically, the extension processor 202 will become idle if it processes all of the data words in the ELDI buffer 202 before the GP microprocessor 204 finishes executing the conditional branch and fetches an additional data word from the memory 206. Unproductive processor clock cycles by the extension processor 202 while the GP microprocessor 204 executes the conditional branch may become relatively large and may significantly limit or even negate the gains in efficiency sought by the implementation of the extension processor 202. This problem may be particularly acute in high performance GP microprocessors 204 with long instruction pipeline since the length of conditional branches is highly unpredictable.

A commonly used solution to this problem is to use a second GP microprocessor to perform low level decoding operations that is independent of the GP microprocessor 204. This solution leaves the GP microprocessor 204 free to concentrate on processing decoded symbols received from the second GP microprocessor. A disadvantage of this approach, however, is the inherent difficulties in debugging and optimizing a multi-processor design. Also, having an additional processor in the design results in higher silicon area (i.e., increased size and costs) and increased power consumption. These are particularly undesirable characteristics in embedded applications, including those for mobile or portable devices, which are often dependent on limited battery power, and seek to utilize an absolute minimum gate count for the requisite functionality in order to optimize power consumption.

A further alternative solution is to increase the amount of data storable in the ELDI buffer 208 in order to reduce the frequency with which the GP processor 204 needs to poll the extension processor 202 to decide whether new data must be fetched from the memory 206. In practice, a large ELDI buffer 208 may be difficult to implement because, in the case of variable-length decoding, the GP microprocessor 204 does not have exact knowledge of when data words stored in the ELDI buffer 208 will finish being forwarded to the extension processor 202. Therefore, the GP microprocessor 204 must still perform the conditional data loading procedure as described above.

Therefore, conventional solutions suffer from these as well as additional shortcomings. It would therefore be highly desirable to provide, inter alia, improved methods and apparatus which would address at least some of the foregoing issues, and improve on processor performance.

### SUMMARY OF THE INVENTION

In view of the above-noted deficiencies of conventional approaches to increasing workflow in microprocessors employing processor extensions, various embodiments of the present invention provide, inter alia, a direct memory access (DMA) mechanism that improves data and computational throughput of a configurable microprocessor employing processor extension logic that does not suffer from any or at least some of these deficiencies.

In a first aspect of the invention, an apparatus is disclosed. In one embodiment, the apparatus comprises: a memory device adapted to store a stream of data; first processor logic in communication with the memory device; second processor logic in communication with the memory device, the second processor logic being adapted to process a segment of the data stream to generate a processed segment, and to forward the processed segment to the first processor logic; a buffer in communication with the second processor and the memory device, the buffer adapted to queue the segment for processing by the second processor logic; and a memory access device adapted to retrieve at least a portion of the data from the memory, the memory access device adapted to monitor a status of the buffer, and request an additional segment of the data stream based at least in part on the status.

In a second aspect of the invention, a method for processing data is disclosed. In one embodiment, the method comprises: receiving first instructions from a processor, the first instructions including a start address and size information; receiving second instructions from a processor extension, the processor extension requesting a segment of the data; computing a system address based on the start address, forwarding the system address and a request for the segment to a memory; receiving the segment from the memory; and forwarding the segment to the processor extension.

In a third aspect of the invention, a method for operating a processor is disclosed. In one embodiment, the method comprises: forwarding a memory instruction to an Operating System (OS), wherein the memory instruction instructs the OS to arrange a data stream into at least one substantially contiguous block in memory; forwarding a start address and size information of the data stream; forwarding a processor instruction instructing the processor to process a segment of the data stream to obtain a symbol; and receiving the symbol from the processor.

In a fourth aspect of the invention, a method is disclosed. In one embodiment, the method comprises: receiving an instruction from a processor to process a segment of a data stream stored in a memory; querying to determine if a buffer contains sufficient data to process the instruction; receiving an indication based at least in part on the query; requesting the segment from the buffer; and processing the segment to obtain a processed segment.

In a fifth aspect of the invention, a data processing apparatus is disclosed. In one embodiment, the apparatus comprises: a buffer module; a processor; a memory; a direct memory access (DMA) assist module configured to receive instructions from the processor to load data from the memory into the buffer module; and a logic module adapted to: i) receive instructions from the processor; ii) determine if the load data in the buffer module is sufficient to process the receive instructions; iii) instruct the direct memory access (DMA) assist module to retrieve additional data and load the additional data into the buffer module until an amount of the load data comprises a sufficient amount to process the receive instructions; and iv) process the receive instructions.

In a sixth aspect of the invention, a method of operating a processor is disclosed. In one embodiment, the method comprises: requesting by the processor to process an instruction; loading a buffer memory with data words; forwarding a physical start address and size information associated with the data words; determining if the data words are sufficient to process the instruction; retrieving at least a portion of the data words using a direct memory access (DMA) assist module; and processing the instruction when the amount of the data words retrieved from the buffer memory is sufficient to process the instruction.

In a seventh aspect of the invention, a direct memory access architecture for use with a user-configurable processor is disclosed. In one embodiment, the architecture comprises: a processor extension logic module adapted to process a first instruction during a substantially similar period as the processor processes a second instruction; a memory associated with the processor; a buffer memory capable of storing at least a portion of information stored in the memory; and a functional unit configured to retrieve at least one data word from the memory in response to a request by the processor extension logic module, and to retrieve any additional data requested from the memory in response to a determination that a contents of the buffer memory comprises insufficient data to process the first instruction.

In an eighth aspect of the invention, apparatus adapted to enhance processing speed of a central processing unit is disclosed. In one embodiment, the apparatus comprises: a module operatively connected with the central processing unit and adapted to: receive instructions from the central processing unit; instruct a buffer memory to be loaded with selected data words from memory; determine when an amount of the selected data words loaded in the buffer memory is sufficient to process the instructions substantially independent of the central processing unit; retrieve additional data words if the amount of the selected data words comprises insufficient information to process the instructions; manipulate the selected data words and the additional data words if the amount of the selected data words and the additional data words comprises sufficient information; extract at least one decoded symbol from the selected data words and the additional data words; and forward the at least one decoded symbol to the central processing unit.

In a ninth aspect of the invention, a processor device is disclosed. In one embodiment, the device comprises: a processing unit; a processor logic extension unit adapted to receive instructions from the processing unit and to perform data manipulations in response to the received instructions; and a direct memory access (DMA) assist module to determine an initial system address corresponding to data words obtained from memory and to determine an updated system address in accordance with an amount of the data words obtained from memory; wherein the direct memory access (DMA) assist module determines the initial and the updated system address substantially independent of processing being performed by the processing unit to reduce wasted instruction execution cycles.

In a tenth aspect of the invention, a processor extension logic device is disclosed. In one embodiment, the device comprises: a receive module operatively connected with a central processing unit to receive at least one instruction from the central processing unit; a transmit module operatively connected with a direct memory access module, the direct memory access module being adapted to: i) fetch at least one data word from memory in response to determining that a memory buffer contains insufficient information to process the at least one instruction; and ii) load the at least one data word into the memory buffer; and a processing module to process the at least one instruction when the memory buffer comprises sufficient data.

In an eleventh aspect of the invention, an integrated circuit (IC) device is disclosed. In one embodiment, the IC device comprises a SoC (system-on-chip) device comprising a processor core, peripherals, and memory. In one variant, the SoC IC is particularly adapted for use in a mobile or portable embedded application, such as a personal media device (PMD).

In a twelfth aspect of the invention, a method of minimizing power consumption in an embedded device is disclosed. In one embodiment, the method comprises operating a processor of the device so as to utilize a DMA assist in order to minimize wasted cycles.

In a thirteenth aspect of the invention, a processor design is disclosed. In one embodiment, the processor design comprises a VHDL, Verilog, or other “soft” representation of a processor core with DMA assist functionality, and the method comprises using a graphical user interface (GUI) based software design environment to both configure and extend a base-case processor core for a particular target application.

In a fourteenth aspect, an embedded device utilizing an enhanced-throughput microprocessor is disclosed. In one embodiment, the microprocessor includes DMA assist functionality, and the device comprises a mobile or portable device such as a telephone, personal media, device, game device, or handheld computer.

These and other aspects of the invention shall become apparent when considered in light of the disclosure provided herein.

### BRIEF DESCRIPTION OF THE DRAWINGS

FIG. 1 is a block diagram depicting an exemplary 32-bit instruction word containing a combination of variable-length symbol words in accordance with various embodiments of the invention;

FIG. 2 is a block diagram illustrating a conventional microprocessor architecture including processor extension logic;

FIG. 3 is a block diagram illustrating an improved microprocessor architecture including a DMA assist mechanism according to at least one embodiment of the invention;

FIG. 4 is a flow chart detailing the steps of an exemplary method performing DMA Assist in a microprocessor employing processor extension logic according to at least one embodiment of the invention;

FIG. 5 is a flow chart detailing the steps of a method performed by a microprocessor implementing a DMA assist mechanism according to at least one embodiment of the invention; and

FIG. 6 is a flow chart detailing the steps of a method for delegating instructions to processor extension logic in a microprocessor architecture.

### DETAILED DESCRIPTION

Reference is now made to the drawings wherein like numerals refer to like parts throughout.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (e.g., BREW), and the like.

As used herein, the terms “extension” and “extension component” generally refer without limitation to one or more logical functions and/or components which can be selectively configured and/or added to an IC design. For example, extensions may comprise an extension instruction (whether predetermined according to a template, or custom generated/configured by the designer) such as rotate, arithmetic and logical shifts within a barrel shifter, MAC functions, swap functions (for swapping upper and lower bytes, such as for Endianess), timer interrupt, sleep, FFT, CMUL, CMAC, XMAC, IPSec, Viterbi butterfly, and the like. Extensions may also include features or components such as multiplier/arithmetic units, functional units, memory, scoreboards, and any number of other features over which a designer may desire to exert design control.

Any references to description language (DL), hardware description language (HDL) or VHSIC HDL (VHDL) contained herein are also meant to include other hardware description languages such as Verilog®, VHDL, Systems C, Java®, CAS, ISS, or any other programming language-based representation of the design, as appropriate. IEEE Std. 1076.3-1997, IEEE Standard VHDL Synthesis Packages, incorporated herein by reference in its entirety, describes an industry-accepted language for specifying a Hardware Definition Language-based design and the synthesis capabilities that may be expected to be available to one of ordinary skill in the art.

As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the term “processor” is meant to include without limitation any integrated circuit or other electronic device (or collection of devices) capable of performing an operation on at least one instruction word including, without limitation, reduced instruction set core (RISC) processors such as for example the ARC family of user-configurable cores provided by the Assignee hereof, central processing units (CPUs), ASICs, and digital signal processors (DSPs). The hardware of such devices may be integrated onto a single substrate (e.g., silicon “die”), or distributed among two or more substrates. Furthermore, various functional aspects of the processor may be implemented solely as software or firmware associated with the processor.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “mobile device” and “portable device” include, but are not limited to, personal digital assistants (PDAs) such as the Blackberry or “Palm®” families of devices, handheld computers, personal communicators, personal media devices (such as e.g., the Apple iPod® or LG Chocolate), J2ME equipped devices, cellular telephones, “SIP” phones, personal computers (PCs) and minicomputers, whether desktop, laptop, or otherwise.

As used herein, the term “network interface” refers to any signal, data, or software interface with a component, network or process including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet™), WiFi (802.11a,b,g,n), WiMAX (802.16), PAN (802.15), or IrDA families.

As used herein, the term “wireless” means any wireless signal, data, communication, or other interface including without limitation WiFi, Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

Overview

The present invention provides, inter alia, a method and apparatus particularly adapted for enhancing the throughput of a digital processor (e.g., microprocessor, CISC device, or RISC device) through use of a direct memory access (DMA) mechanism. In one embodiment, the processor comprises a “soft” RISC-based processor core that is both user-extensible and user-configurable. The core comprises a functional process or unit (DMA “assist”) that is coupled to the processor's extension logic and which facilitates throughput by, among other things, ensuring that the CPU and processor extension logic can operate on data in parallel in an efficient manner.

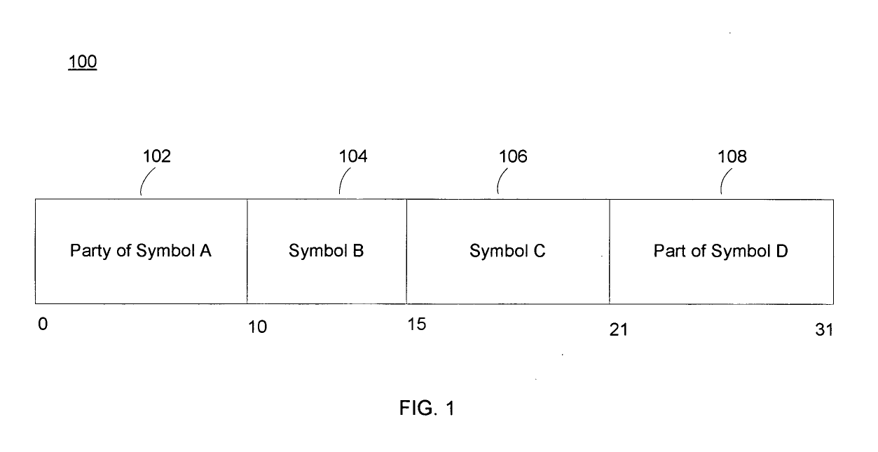

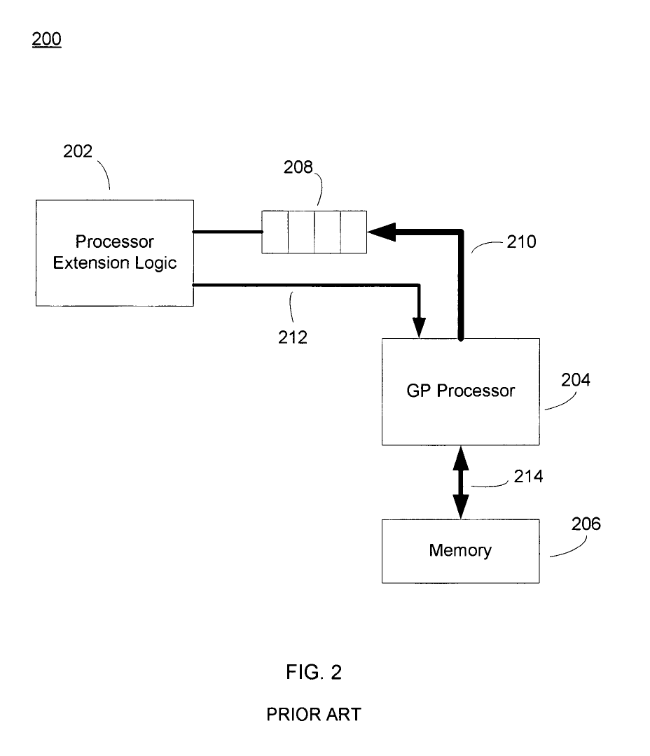

In one variant, a parallel datapath (including a buffer) is used in conjunction with the aforementioned DMA assist so as to permit the processor extension logic to efficiently operate in parallel with the CPU. This provides a significant performance improvement over prior art approaches such as those previously described with respect to FIGS. 1 and 2 herein. It also allows for reduced complexity and gate count (and hence reduced power consumption) as compared to e.g., prior art solutions having multiple general purpose CPUs.

The aforementioned parallel datapath also advantageously provides for a single thread of software control, thereby greatly simplifying debugging and other such operations.

The DMA assist can readily be incorporated into processor core configurations at time of design, and may be optimized for the intended or target application(s). Moreover, the extension logic unit can be configured as desired, and the two (logic unit and DMA assist) optimized as part of a common design.

### Description of the Exemplary Embodiments

The following description is intended to convey a thorough understanding of the invention by providing a number of specific exemplary embodiments and details involving a method and apparatus for improving processor efficiency. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

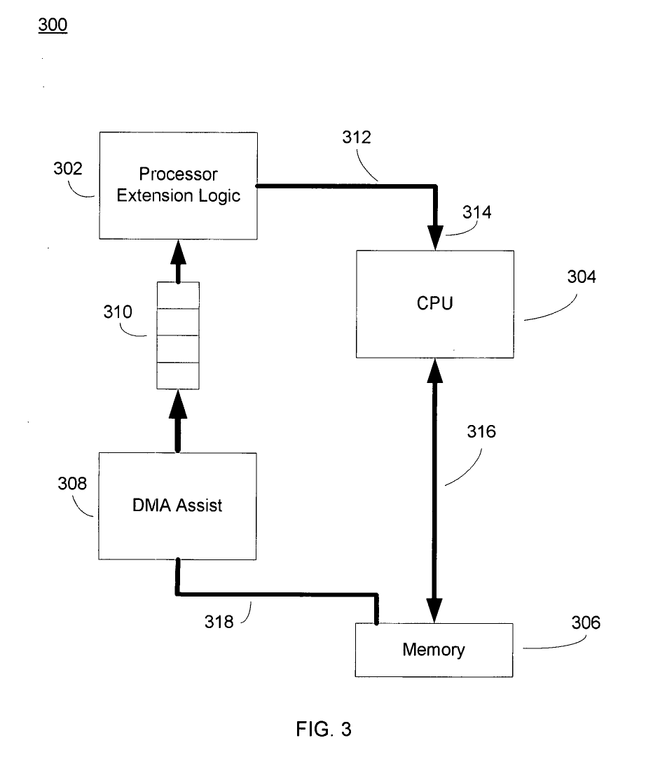

One exemplary embodiment of the invention is now described referring to FIG. 3. As shown in FIG. 3, one aspect of the present invention comprises an architecture 300 of a direct-memory-access (DMA) mechanism to improve data and computational throughput of a configurable microprocessor. The architecture 300 may include processor extension logic 302, a central processing unit (CPU) 304, a memory 306, a direct memory access (DMA) assist 308, and an extension logic data input (ELDI) buffer 310.

Also depicted in FIG. 3 are a result datapath 312 that couples the processor extension logic 302 with an extension interface 314 of the CPU 304, a CPU memory interface 316 that couples the CPU 304 with the memory 306, and a DMA memory interface 318 that couples the DMA assist 308 with the memory 306. An extension datapath of the architecture 300 begins at memory 306, continues to the DMA assist 308, further continues to the ELDI buffer 310, continues to the processor extension logic 302, and ends at the CPU 304.

In various exemplary embodiments, the CPU 304 and the processor extension logic 302 may operate on data simultaneously to improve the efficiency of data throughput. The CPU 304 may retrieve data from the memory 306 through the CPU memory interface 316 and place the data in a CPU queue within the CPU 304. The data may be a sequence of instructions performed by the CPU 304. If the CPU 304 encounters an instruction that would best be handled by the processor extension logic 302, the CPU 304 may instruct the processor extension logic 302 to process the data while the CPU 304 processes other instructions in the CPU queue. Having multiple devices, such as the CPU 304 and the processor extension logic 302, simultaneously processing data may be referred to as parallel processing. Parallel processing may be particularly advantageous since it may increase the efficiency in processing a sequence of instructions and/or data as compared with a single device processing the instructions and/or data. An advantage of the kind of parallel processing exemplified in FIG. 3 is that there is only one single thread of control for the programmer. Traditionally, parallel machines are difficult to program and debug because they require coordination of multiple threads of program executions that interact asynchronously. With a single thread of execution, this major problem with traditional parallel processing computer systems is eliminated.

In various exemplary embodiments, the processor extension logic 302 may be specifically designed to support specialized instructions that greatly accelerate the execution of specific computations required by the CPU 304. The processor extension logic 302 may be logic that processes data having a high degree of data parallelism, including, but not limited to, performing low level bit manipulation of a large set of data such as is common in video encoding and decoding applications. The processor extension logic 302 may process data, such as, but not limited to, compressed variable length encoded bit-stream data, variable-length encoded (VLC) data, or other types of processed data. In various exemplary embodiments, the processor extension logic 302 may include variable-length coded (VLC) decode logic for decoding VLC schemes such as, but not limited to, Huffman code, Context-Adaptive Variable Length Coding (CAVLC), and Context-Adaptive Binary Arithmetic Coding (CABAC). Processing of the data may include, but is not limited to, decoding, decryption, encoding, and other computationally intensive applications such as, for example, but not limited to, video and/or audio processing applications. The processor extension logic 302 may efficiently process the compressed VLC encoded bit-stream data to generate a sequence of one or more processed symbols.

In various exemplary embodiments, once the CPU 304 encounters an instruction for manipulating data that may be processed by the processor extension logic 302, the CPU 304 may instruct the DMA assist 308 to load the ELDI buffer 310 with data words from a compressed VLC encoded bit-stream stored in the memory 306 (see FIG. 3). To set up this DMA mechanism, the CPU 304 may forward to the DMA assist 308 a physical start address and size information on a size of the compressed VLC encoded bit-stream (e.g., number of bits, number of data words, etc.) stored in the memory 306. In various exemplary embodiments, prior to forwarding the physical start address and the size information, the CPU 304 may instruct the OS to place the entire compressed VLC encoded bit-stream data into one contiguous block in the memory 306.

After forwarding the physical start address and the size information, the CPU 304 may instruct the processor extension logic 302 to extract decoded symbols from the compressed VLC encoded bit-stream data. Alternatively, the CPU 304 may periodically, aperiodically, or continuously issue instructions to the Processor extension logic 302. After receiving the instruction, the processor extension logic 302 may determine if the ELDI buffer 310 contains a sufficient amount of data words to process instructions issued by the CPU 304. If the ELDI buffer 310 does contain a sufficient amount of data words, the processor extension logic 302 may retrieve one or more data words from the ELDI buffer 310 and may process the one or more data word to obtain one or more symbols. Once obtained, the processor extension logic 302 may then forward the one or more symbols to the CPU 304 through the result datapath 312 and the extension interface 314.

When the processor extension logic 302 detects that the ELDI buffer 310 requires one or more additional data words to process the instruction of the CPU 304, the processor extension logic 302 may instruct the DMA assist 308 to fetch one or more data words of the compressed VLC encoded bit-stream data stored in the memory 306 through the DMA memory interface 318.

Once instructed by the processor extension logic 302, the DMA assist 308 may automatically compute a system address corresponding to a first data word to be obtained from the memory 306. Initially, the system address may be the physical start address received from the CPU 304. The physical start address may indicate the memory address of the first data word for the contiguous block of compressed VLC encoded bit-stream data stored in the memory 306. To determine subsequent system addresses after the DMA assist 308 has retrieved one or more data words, the DMA assist 308 may compute the subsequent system address based on the physical start address and the number of fixed length data words (see, e.g., FIG. 1) previously retrieved from the memory 306.

Once the system address is determined, the DMA assist 308 may then send the system address to the memory 306 along with a request for one or more data words. The memory 306 may then retrieve one or more words from the compressed VLC encoded bit-stream data beginning at the system address and may forward the retrieved one or more words to the DMA assist 308. The memory 306 may also include an indicator notifying the DMA assist 308 when the last data word of the compressed VLC encoded bit-stream has been forwarded. The DMA assist 308 may determine the number of data words retrieved for updating the system address. The DMA assist 308 may forward the one or more data words to the ELDI buffer 310. Once received, the ELDI buffer 310 may queue the one or more data words and may inform the processor extension logic 302 that one or more data words have been received. The processor extension logic 302 may then request to retrieve one or more of the data words from the ELDI buffer 310. The processor extension logic 302 may then process one or more data words to obtain one or more symbols and may forward the one or more decoded symbols to the CPU 304.

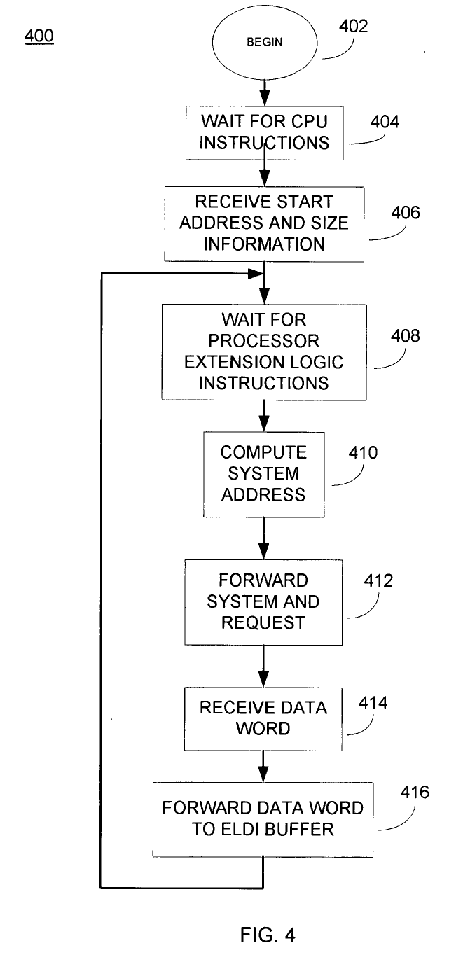

The following refers to flow diagram 400 depicted in FIG. 4 detailing the steps of performing DMA assist in a microprocessor employing processor extension logic according to an exemplary embodiment of the present invention. The method may begin in step 402 and may then continue to 404. In step 404, the DMA assist 308 may wait for the CPU 304 to generate instructions. The instructions may inform the DMA assist 308 the physical start address of the compressed VLC encoded bit-stream data stored in the memory 306 and may include size information about the number of bits or data words of the compressed VLC encoded bit-stream data. Operation of the method may then proceed to step 406.

In step 406, the DMA assist 308 may receive the instructions from the CPU 304. Then, in step 408, the DMA assist 308 may wait for instructions from the processor extension logic 302. The instructions from the processor extension logic 302 may instruct the DMA assist 308 to obtain one or more data words from the memory 306. Next, in step 410, once the DMA assist 308 receives the instructions from the processor extension logic 302, the DMA assist 308 may compute the system address. Once the DMA assist 308 computes the system address, operation of the method may proceed to step 412.

In step 412, the DMA assist 308 may forward the system address and a request to the memory 306. In various embodiments, the request may identify the number of data words for the memory 306 to retrieve and forward to the DMA assist 308. Then, in step 414, the DMA assist 308 waits for the memory 306 to retrieve the one or more data words. In 416, upon receipt of the one or more data words from the memory 306, the DMA assist 308 may update the number of data words received from the memory 306 and may forward the received data words to the ELDI buffer 310. Operation of the method may then continue to step 418.

In step 418, the DMA assist 308 may determine whether the memory 306 has forwarded the indicator that indicates the last data word has been retrieved. If the DMA assist 308 determines that the last data word has not been retrieved, operation of the method may return to step 408. Otherwise, operation of the method proceeds to 420 and ends.

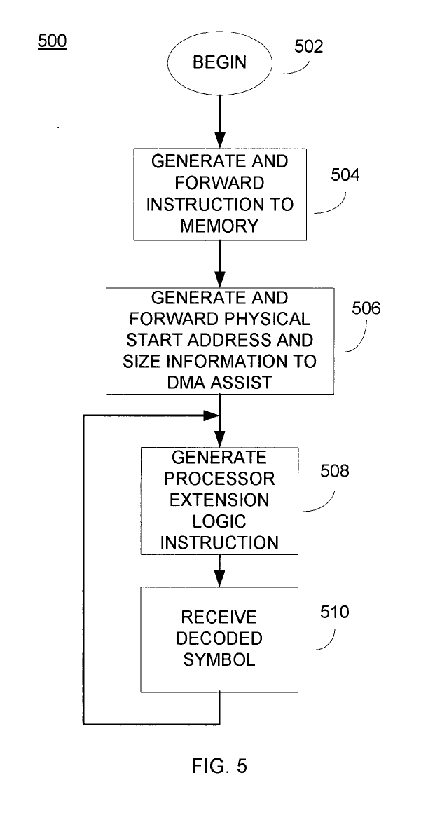

Referring now to FIG. 5, a flow chart 500 details the steps of a method performed at the CPU 304, according to at least one embodiment of the invention is depicted. The method may begin in 502 and proceed to step 504.

In step 504, the CPU 304 may generate and forward an instruction to the OS. The instruction may instruct the OS to place the compressed VLC encoded bit-stream data in a contiguous block in the memory 306. Alternatively, this operation may be skipped. Next, in step 506, once the CPIJ 304 encounters an instruction for manipulating the compressed VLC encoded bit-stream data that may be processed by the processor extension logic 302, the CPU 304 may generate and forward to the DMA assist 308 a physical start address and size information of the compressed VLC encoded bit-stream data.

Then, in step 508, the CPU 304 may generate an instruction for the processor extension logic 302 requesting decoding of data from the compressed VLC encoded bit-stream data. In various exemplary embodiments, the instruction may request that one or more symbols or one or more data words be decoded by the processor extension logic 302. Operation of the method may then proceed to step 510. In step 510, the CPU 304 may wait for and receive one or more decoded symbols from the processor extension logic 302. In step 512, the CPU may determine whether all symbols in the VLC encoded bit-stream have been decoded. If no, then operation of the method may return directly to step 508 by which the CPU 304 can again generate instructions for the processor extension logic 302 requesting one or more symbols from the VLC encoded bit-stream. This is possible because the DMA Assist 308 allows the processor extension logic 302 to work autonomously without further intervention from the CPU 304. When all symbols in the VLC encoded bit-stream have been decoded, operation of the method may then proceed to step 514 and end.

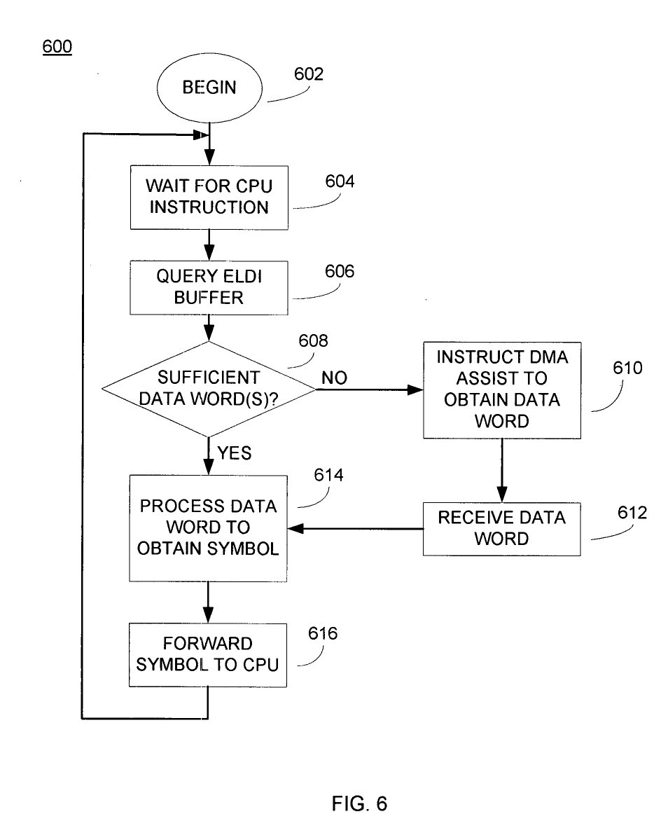

FIG. 6 is a flow chart detailing the steps of operations performed by the processor extension logic 302 according to at least one exemplary embodiment of the invention. After the DMA assist 308 has received the physical start address and size information from the CPU 304, the method may begin at step 602 and proceed to step 604. In step 604, the processor extension logic 302 may wait for an instruction from the CPU 304 to process compressed VLC encoded bit-stream data. The instruction may request that the processor extension logic 302 decode one or more data words from the compressed VLC encoded bit-stream data to obtain one or more symbols. Step 604 corresponds to step 508 in FIG. 5. Operation of the method may then proceed to step 606.

In step 606, once the processor extension logic 302 has received the instruction from the CPU 304, the processor extension logic 302 may query the ELDI buffer 310 to determine if the buffer contains a sufficient number of data words to process the instruction from the CPU 304. In step 608, if the processor extension logic 302 determines that the buffer contains a sufficient number of data words to process the instruction from the CPU 304, the processor extension logic 302 may request and may receive one or more data words from the ELDI buffer 310, and operation may continue to step 614. Otherwise, operation of the method continues to step 610.

In step 610, the processor extension logic 302 may instruct the DMA assist 308 to obtain one or more data words from the memory 306. Then, in step 612, once the ELDI buffer 310 informs the processor extension logic 302 that the ELDI buffer 310 has received one or more data words from the DMA assist 308, the processor extension logic 302 may request and receive one or more data words from the ELDI buffer 310. Operation of the method may then proceed to step 614.

In step 614, the processor extension logic 302 may then process the data word to obtain one or more symbols. Then, in step 616, the processor extension logic 302 may then forward one or more symbols to the CPU 304. Step 616 corresponds to step 510 in FIG. 5. Subsequently, operation of the method may then return to step 604.

Thus, the architecture 300 according to the various embodiments of the invention provides efficiencies over conventional systems. These efficiencies occur because the CPU 304 may no longer have to compute and issue the system address to retrieve data from the memory 306 each time the processor extension logic 302 requires additional data words. This eliminates wasted instruction execution cycles where the processor extension logic 302 waits on the CPU 304 to finish executing a conditional branch before retrieving additional data words. Moreover, the CPU 304 may no longer be required to check the status of the ELDI buffer 310 to determine if the ELDI buffer 310 is empty or requires additional data words. The processor extension logic 302 may monitor the ELDI buffer 310 and may issue an instruction to the DMA assist 308 to obtain one or more data words from the memory 306 without having to wait on a load instruction from the CPU 304. Furthermore, loading data into the ELDI buffer 310 only when needed is particularly efficient for VLC decoding since the input data word is much smaller than the generated output symbol.

It is noted that the above description describes various devices, such as the CPU 304, the DMA assist 308, and the processor extension logic 302 performing certain functions. These functions, however, may be performed by one or more other devices within the architecture 300. For example, the processor extension logic 302 may receive the physical start address and size information from the CPU 304, instead of the DMA assist 308. Analogously, other devices in the architecture 300 may perform the various functions described herein.

Moreover, the architecture 300 may also use other combinations and subcombinations of components. For example, the processor extension logic 302 may include the DMA assist 308, the ELDI buffer 310, various other components, and combinations thereof. Moreover, though in various embodiments, the DMA assist 308 is described as separate from the extension logic 302, it should be appreciated that in various embodiments, the DMA assist 308 may be considered part of the extension logic. In such embodiments, the extension logic is effectively performing the function of the DMA assist because the DMA assist is part of the extension logic, rather than a separate interface from the primary instruction pipeline to the extension logic. Such variations are within the scope of the various embodiments of the invention.

Integrated Circuit Design and Device

The Assignee's ARC processor core (e.g., ARC 600 and ARC 700) configuration is used as the basis for one embodiment of an integrated circuit (IC) device employing certain exemplary aspects and features of the invention described herein; however, other arrangements and configurations may be substituted if desired. The exemplary device is fabricated using e.g., the customized VHDL design obtained using techniques such as those described in U.S. Pat. No. 6,862,563 to Hakewill, et al. issued Mar. 1, 2005 entitled “METHOD AND APPARATUS FOR MANAGING THE CONFIGURATION AND FUNCTIONALITY OF A SEMICONDUCTOR DESIGN”, U.S. patent application Ser. No. 10/423,745 filed Apr. 25, 2003 entitled “APPARATUS AND METHOD FOR MANAGING INTEGRATED CIRCUIT DESIGNS”, and/or U.S. patent application Ser. No. 10/651,560 filed Aug. 29, 2003 and entitled “COMPUTERIZED EXTENSION APPARATUS AND METHODS”, each of the foregoing incorporated herein by reference in its entirety, which is then synthesized into a logic level representation, and then reduced to a physical device using compilation, layout and fabrication techniques well known in the semiconductor arts. For example, the present invention is compatible with e.g., 0.13, 0.1 micron, 78 nm, and 50 nm processes, and ultimately may be applied to processes of even smaller or other resolution.

It will be recognized by one skilled in the art that the IC device of the present invention may also contain any commonly available peripheral such as serial communications devices, parallel ports, timers, counters, high current drivers, analog to digital (A/D) converters, digital to analog converters (D/A), interrupt processors, LCD drivers, memories and memory interfaces, network interfaces, wireless transceivers, and other similar devices. Further, the processor may also include other custom or application specific circuitry, such as to form a system on a chip (SoC) device useful for providing a number of different functionalities in a single package as previously referenced herein. The present invention is not limited to the type, number or complexity of peripherals and other circuitry that may be combined using the method and apparatus. Rather, any limitations are primarily imposed by the physical capacity of the extant semiconductor processes which improve over time. Therefore it is anticipated that the complexity and degree of integration possible employing the present invention will further increase as semiconductor processes improve.

In one exemplary embodiment, the processor design of the present invention utilizes the ARCompact™ ISA of the Assignee hereof. The ARCompact ISA is described in greater detail in co-pending U.S. patent application Ser. No. 10/356,129 entitled “CONFIGURABLE DATA PROCESSOR WITH MULTI-LENGTH INSTRUCTION SET ARCHITECTURE” filed Jan. 31, 2003, assigned to the Assignee hereof, and incorporated by reference herein in its entirety. The ARCompact ISA comprises an instruction set architecture (ISA) that allows designers to freely mix 16- and 32-bit instructions on its 32-bit user-configurable processor. A key benefit of the ISA is the ability to cut memory requirements on a SoC (system-on-chip) by significant percentages, resulting in lower power consumption and lower cost devices in deeply embedded applications such as wireless communications and high volume consumer electronics products.

The main features of the ARCompact ISA include 32-bit instructions aimed at providing better code density, a set of 16-bit instructions for the most commonly used operations, and freeform mixing of 16- and 32-bit instructions without a mode switch—significant because it reduces the complexity of compiler usage compared to competing mode-switching architectures. The ARCompact instruction set expands the number of custom extension instructions that users can add to the base-case ARC™ processor instruction set. With the ARCompact ISA, users can add literally hundreds of new instructions. Users can also add new core registers, auxiliary registers, and condition codes. The ARCompact ISA thus maintains and expands the user-customizable and extensible features of ARC's extensible processor technology.

The ARCompact ISA delivers high density code helping to significantly reduce the memory required for the embedded application. In addition, by fitting code into a smaller memory area, the processor potentially has to make fewer memory accesses. This can cut power consumption and extend battery life for portable devices such as MP3 players, digital cameras and wireless handsets. Additionally, the shorter instructions can improve system throughput by executing in a single clock cycle some operations previously requiring two or more instructions. This can boost application performance without having to run the processor at higher clock frequencies. When combined with the enhanced throughput and efficiency features of the present invention relating to inter alia the DMA assist, the ARCompact ISA provides yet further benefits in terms of reduced memory requirements and efficiency.

In addition to the foregoing, the integrated circuit device of the present invention may be combined with other technologies that enhance one or more aspects of its operation, code density, spatial density/gate count, power consumption, etc., or so as to achieve a particular capability or functionality. For example, the technologies described in co-owned and co-pending U.S. patent application Ser. No. 11/528,432 filed Sep. 28, 2006 entitled “SYSTOLIC-ARRAY BASED SYSTEMS AND METHODS FOR PERFORMING BLOCK MATCHING IN MOTION COMPENSATION”; U.S. patent application Ser. No. 11/528,325 filed Sep. 28, 2006 entitled “SYSTEMS AND METHODS FOR ACCELERATING SUB-PIXEL INTERPOLATION IN VIDEO PROCESSING APPLICATIONS”; U.S. patent application Ser. No. 11/528,338 filed Sep. 28, 2006 entitled “SYSTEMS AND METHODS FOR RECORDING INSTRUCTION SEQUENCES IN A MICROPROCESSOR HAVING A DYNAMICALLY DECOUPLEABLE EXTENDED INSTRUCTION PIPELINE”; U.S. patent application Ser. No. 11/528,327 filed Sep. 28, 2006 entitled “SYSTEMS AND METHODS FOR PERFORMING DEBLOCKING IN MICROPROCESSOR-BASED VIDEO CODEC APPLICATIONS”; U.S. patent application Ser. No. 11/528,470 filed Sep. 28, 2006 entitled “SYSTEMS AND METHODS FOR SYNCHRONIZING MULTIPLE PROCESSING ENGINES OF A MICROPROCESSOR”; U.S. patent application Ser. No. 11/528,434 filed Sep. 28, 2006 entitled “SYSTEMS AND METHODS FOR SELECTIVELY DECOUPLING A PARALLEL EXTENDED INSTRUCTION PIPELINE”; U.S. patent application Ser. No. 11/528,326 filed Sep. 28, 2006 entitled “PARAMETERIZABLE CLIP INSTRUCTION AND METHOD OF PERFORMING A CLIP OPERATION USING SAME”; and U.S. patent application Ser. No. 60/849,443 filed Oct. 5, 2006 and entitled “INTERPROCESSOR COMMUNICATION METHOD”, each of the foregoing incorporated herein by reference in its entirety, may be used consistent with technology described herein.

The embodiments of the present inventions are not to be limited in scope by the specific embodiments described herein. For example, although many of the embodiments disclosed herein have been described with reference to systems and methods for microprocessor architecture, the principles herein are equally applicable to other aspects of microprocessor design and function. Indeed, various modifications of the embodiments of the present inventions, in addition to those described herein, will be apparent to those of ordinary skill in the art from the foregoing description and accompanying drawings.

Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes.

What is claimed is:

1. A data processing apparatus, comprising:
a buffer module;
a processor;
a memory;
a direct memory access (DMA) assist module configured to receive instructions from the processor to load data from the memory into the buffer module; and
a logic module adapted to:
i) receive instructions from the processor;
ii) determine if the load data in the buffer module is sufficient to process the receive instructions;
iii) instruct the direct memory access (DMA) assist module to retrieve additional data and load the additional data into the buffer module until an amount of the load data comprises a sufficient amount to process the receive instructions; and
iv) process the receive instructions.

2. The apparatus as set forth in claim 1, wherein said logic module comprises processor extension logic capable of processing a variable length coded (VLC) bit-stream, and instructing the direct memory access (DMA) assist module to directly compute a system address to retrieve the load data and the additional data from the memory.

3. The apparatus as set forth in claim 1, wherein the load data comprises data words from a compressed variable length coded (VLC) bit-stream.

4. The apparatus as set forth in claim 1, wherein the processor is adapted to forward to the direct memory access (DMA) assist module a physical start address and size information of the load data.

5. The apparatus as set forth in claim 3, wherein the processor is configured to instruct the logic module to extract decoded symbols from the compressed variable length coded (VLC) bit-stream.

6. The apparatus as set forth in claim 1, wherein the processor and the logic module are capable of substantially parallel processing at least one of a sequence of instructions or the load data.

7. The apparatus as set forth in claim 1, wherein said processor comprises a user-configurable and extendible RISC core.

8. The apparatus as set forth in claim 7, wherein said user-configurable and extendible RISC core comprises a multi-length instruction set architecture (ISA), said ISA comprising a plurality of instructions of a first length and a plurality of instructions of a second length, said pluralities able to be freely intermixed.

9. The apparatus as set forth in claim 8, wherein said first length comprises 16-bits, and said second length comprises 32-bits, and said 16-bit and 32-bit instructions can be used without a processor mode switch.

10. A method of operating a processor, comprising:
requesting by the processor to process an instruction;
loading a buffer memory with data words;
forwarding a physical start address and size information associated with the data words;
determining if the data words are sufficient to process the instruction;
retrieving at least a portion of the data words using a direct memory access (DMA) assist module; and
processing the instruction when the amount of the data words retrieved from the buffer memory is sufficient to process the instruction.

11. The method a set forth in claim 10, wherein the data words comprise a compressed variable logic encoded (VCL) bit-stream.

12. The method as set forth in claim 10, further comprising receiving an instruction by the direct memory access (DMA) assist module to fetch the at least portion of the data words through a direct memory access (DMA) memory interface.

13. The method as set forth in claim 10, further comprising computing substantially automatically by the direct memory access (DMA) assist module a system address corresponding to a first data word of the at least portion of the data words.

14. The method as set forth in claim 13, further comprising directly computing by the direct memory access (DMA) assist module a subsequent system address based on a physical start address and a number of fixed length data words retrieved from memory.

15. The method as set forth in claim 13, further comprising:
transmitting the system address to a memory bank along with a request for additional data words;
retrieving by the direct memory access (DMA) assist module the additional data words;
determining by the direct memory access (DMA) assist module an updated system address at least partially in response to an addition of the additional data words; and
forwarding the additional data words to the buffer memory.

16. A direct memory access architecture for use with a user-configurable processor, the architecture comprising:
a processor extension logic module adapted to process a first instruction during a substantially similar period as the processor processes a second instruction;
a memory associated with the processor;
a buffer memory capable of storing at least a portion of information stored in the memory; and
a functional unit configured to retrieve at least one data word from the memory in response to a request by the processor extension logic module, and to retrieve any additional data requested from the memory in response to a determination that a contents of the buffer memory comprises insufficient data to process the first instruction.

17. The architecture as set forth in claim 16, wherein said functional unit comprises a direct memory access (DMA) assist module.

18. The architecture as set forth in claim 16, wherein the buffer memory is further configured to queue the at least one data word, and to inform the processor extension logic that the at least one data word has been received.

19. The architecture as set forth in claim 16, wherein the processor extension logic module is configured to process the at least one data word to obtain one or more symbols, and to forward the one or more symbols to the processor.

20. The architecture as set forth in claim 16, wherein the processor extension logic module is configured to determine if the buffer memory comprises a sufficient amount of data words to process the first instruction.

21. The architecture of claim 17, wherein at least one of the first instruction and the second instruction comprise a portion of a compressed variable length code (VLC) bit-stream; and
wherein the direct memory access (DMA) assist module computes the system address corresponding to a first data word of the compressed variable length code (VLC) bit-stream.

22. Apparatus adapted to enhance processing speed of a central processing unit, the apparatus comprising:
a module operatively connected with the central processing unit and adapted to:
receive instructions from the central processing unit;
instruct a buffer memory to be loaded with selected data words from memory;
determine when an amount of the selected data words loaded in the buffer memory is sufficient to process the instructions substantially independent of the central processing unit;
retrieve additional data words if the amount of the selected data words comprises insufficient information to process the instructions;
manipulate the selected data words and the additional data words if the amount of the selected data words and the additional data words comprises sufficient information;
extract at least one decoded symbol from the selected data words and the additional data words; and
forward the at least one decoded symbol to the central processing unit.

23. The apparatus of claim 22, wherein the module is further adapted to determine a system address of the selected data words.

24. The apparatus of claim 22, wherein the module is further adapted to determine an updated system address based in part on a number of the additional words retrieved without requiring additional execution cycle timing by the central processing unit.

25. A processor device, comprising:
a processing unit;
a processor logic extension unit adapted to receive instructions from the processing unit and to perform data manipulations in response to the received instructions; and
a direct memory access (DMA) assist module to determine an initial system address corresponding to data words obtained from memory and to determine an updated system address in accordance with an amount of the data words obtained from memory;
wherein the direct memory access (DMA) assist module determines the initial and the updated system address substantially independent of processing being performed by the processing unit to reduce wasted instruction execution cycles.

26. A processor extension logic device, comprising:
a receive module operatively connected with a central processing unit to receive at least one instruction from the central processing unit;
a transmit module operatively connected with a direct memory access module, the direct memory access module being adapted to:
i) fetch at least one data word from memory in response to determining that a memory buffer contains insufficient information to process the at least one instruction; and
ii) load the at least one data word into the memory buffer; and a processing module to process the at least one instruction when the memory buffer comprises sufficient data.

27. The device as set forth in claim 26, wherein the processor extension logic device operatively cooperates with the central processing unit to process data or the at least one instruction in a substantially parallel manner to reduce occurrence of wasted execution cycles.

28. The device as set forth in claim 26, wherein the direct memory access module is further adapted to determine a system address substantially independent of the central processing unit.

29. The device as set forth in claim 26, wherein the direct memory access module is further adapted to determine whether the memory has forwarded an indicator that indicates that a last data word of a data stream has been retrieved.

30. The device as set forth in claim 26, wherein the direct memory access module is further adapted to wait for the central processing unit to generate the at least one instruction before proceeding.

31. The device as set forth in claim 30, wherein the at least one instruction comprises a physical start address of a compressed variable length coded (VLC) encoded bit-stream data stored in the memory and size information on a number of bits or data words of the bit-stream data.

32. Processor apparatus, comprising:
a memory device adapted to store a stream of data;
first processor logic in communication with the memory device;
second processor logic in communication with the memory device, the second processor logic being adapted to process a segment of the data stream to generate a processed segment, and to forward the processed segment to the first processor logic;
a buffer in communication with the second processor and the memory device, the buffer adapted to queue the segment for processing by the second processor logic; and
a memory access device adapted to retrieve at least a portion of the data from the memory, the memory access device adapted to monitor a status of the buffer, and request an additional segment of the data stream based at least in part on the status.

33. The processor apparatus of claim 32, wherein said processor apparatus comprises a user-extendible and user-configurable processor core.

34. The processor apparatus of claim 32, wherein at least one of said first and second processor logic comprises user-configured extension logic.

35. A method for processing data, comprising:
receiving first instructions from a processor, the first instructions including a start address and size information;
receiving second instructions from a processor extension, the processor extension requesting a segment of the data;
computing a system address based on the start address,
forwarding the system address and a request for the segment to a memory;
receiving the segment from the memory; and
forwarding the segment to the processor extension.

36. A method of operating a processor having a processing unit, comprising:
forwarding a memory instruction to an Operating System (OS), wherein the memory instruction instructs the OS to arrange a data stream into at least one substantially contiguous block in memory;
forwarding a start address and size information of the data stream;
forwarding a processor instruction instructing the processing unit to process a segment of the data stream to obtain a symbol; and
receiving the symbol from the processing unit.

37. A processor device, comprising:
a processing unit;
a direct memory access (DMA) assist module; and
a processor logic extension unit adapted to receive instructions from the processing unit and to perform data manipulations in response to the received instructions, the extension unit comprising:
a receive module operatively connected with the processing unit to receive at least one instruction from the processing unit;
a transmit module operatively connected with a direct memory access module, the direct memory access module being adapted to:
i) fetch at least one data word from memory in response to determining that a memory buffer contains insufficient information to process the at least one instruction; and
ii) load the at least one data word into the memory buffer; and
a processing module to process the at least one instruction when the memory buffer comprises sufficient data;
wherein the direct memory access (DMA) assist module determines an initial and updated system address substantially independent of processing being performed by the processing unit to reduce wasted instruction execution cycles.
